(19) United States
(12) Patent Application Publication
(10) Pub. No.: US 2002/0042474 A1
(43) Pub. Date: Apr. 11, 2002

(54) Mixtures of an aromatic vinyl resin and of polyphenylene ether with improved impact strength

(76) Inventors: Francois Court, Fontaine L' Abbe (FR); Ludwik Leibler, Paris (FR); Anthony Bonnet, Serquigny (FR); Denis Bertin, Plan De Cuques (FR)

Correspondence Address: SMITH, GAMBRELL & RUSSELL, LLP, 1850 M Street, N.W., Suite 800, Washington, DC, 20036, US

(21) Appl. No.: 09/884,108

(22) Filed: Jun. 20, 2001

(30) Foreign Application Priority Data
Jun. 20, 2000 (FR) 00.07848

(51) Int. Cl. C08L 53/00

(52) U.S. Cl. 525/88

(57) ABSTRACT

The present invention relates to a rigid material based on PPO and an aromatic vinyl resin with improved impact strength comprising:

99 to 20% of a resin (A) consisting of a mixture of PPO and of an aromatic vinyl resin,

1 to 80% of an impact modifier comprising at least one block copolymer S-B-M in which:

each block is linked to the other by means of a covalent bond or an intermediate molecule linked to one of the blocks by a covalent bond and to the other block by another covalent bond,

M consists of MMA monomers optionally copolymerized with other monomers and comprises at least 50% by weight of methyl methacrylate (MMA),

B is incompatible with the resin (A) and with the M block and its glass transition temperature Tg is less than the temperature for using the rigid material,

S is incompatible with the B block and the M block and its Tg or its melting point m.p. is greater than the Tg of B,

S is compatible with the resin (A).

The aromatic vinyl resin is advantageously polystyrene and the triblock S-B-M consists of polystyrene, polybutadiene and PMMA respectively.

### FIELD OF THE INVENTION

The present invention relates to mixtures of an aromatic vinyl resin and of polyphenylene ether with improved impact strength and more particularly mixtures of polystyrene (PS) and of polyphenylene ether (PPO) with improved shock resistance. The PPO/PS mixture is a rigid material which has a high Vicat temperature but which is extremely fragile. The polystyrene may be an ordinary polystyrene or a grade of polystyrene strengthened against impact which is designated PCchoc or HIPS (abbreviation of High Impact Polystyrene). The invention relates to PPO/PS mixtures to which triblock copolymers S-B-M have been added in order to improve their impact strength. These triblocks consist for example of a polystyrene block (S block), a polybutadiene block (B block) and a PMMA block (M block).

### BACKGROUND OF THE INVENTION

The PPO/PS mixture (control 1 in the [Examples] below) is a rigid material (flexural modulus 2820 MPa) which has a high Vicat temperature but which is extremely fragile. It is known that the replacement of polystyrene with a grade of polystyrene strengthened against impact makes it possible to significantly improve the impact strength of the PPO/PS mixture (control 2 in the [Examples] below). This improvement in impact results in a slight decrease in the modulus and a slight decrease in the Vicat temperature.

For some applications, the strengthening obtained using a PSchoc in a PPO/PS mixture is not sufficient. To resolve this difficulty, many studies and patents describe the use of linear or star-shaped block copolymers S-B-S, of S-EB-S and of S-B-polycaprolactone for improving impact. The block copolymers S-B-S consist for example of a polystyrene block (S block), of a polybutadiene block (B block) and of another polystyrene block. The S-EB-Ss are S-B-S block copolymers in which the B block has been hydrogenated. The S-B-polycaprolactone copolymers consist of a polystyrene block (S block), of a polybutadiene block (B block) and of a polycaprolactone block.

The strengthening of the PPO/PS mixtures with S-EB-S block copolymers by the addition of 20% of S-EB-S triblock allows a very substantial improvement in the impact strength at room temperature. The improvement in the impact strength at low temperature (−30° C.) is more limited but remains substantial. On the other hand, the addition of S-EB-S results in a very substantial decrease in the stiffness of the material. Indeed, a decrease in flexural modulus of 700 MPa is observed. Furthermore, this decrease in modulus is accompanied by a decrease in the Vicat temperature of the order of 15 to 20° C. which may rule out the applications of these mixtures.

Patent EP 0 086 448 shows that the strengthening obtained with a star-shaped S-B-S marketed by the company Phillips Petroleum under the reference Solprene 411 is identical to that obtained with an S-B-polycaprolactone triblock. Likewise, the heat-distortion temperature (HDT) of the materials obtained from these two copolymers are comparable. The only advantage of using the block copolymers comprising a polycaprolactone block is that the compositions obtained are more fluid and therefore easier to use, for example for injection into a mould.

It has now been found that the addition of an S-B-M triblock (for example PS-PB-PMMA) to the PPO/PS and PPO/PSchoc mixtures does not penalize fluidity compared with the addition of an S-EB-S triblock. The strengthening obtained is slightly lower at room temperature but it is amply sufficient; on the other hand, the S-B-M triblocks make it possible to obtain a higher strengthening at lower temperature (−30° C.). The most surprising result lies nevertheless in the thermomechanical behaviour of the products. Indeed, compared with the addition of an S-EB-S triblock, the improvement in the impact properties is only obtained at the expense of a tiny decrease in the flexural modulus (400 MPa) and a very limited decrease of the order of 4 to 5° C. in the Vicat temperature.

More generally, the S-B-M triblocks allow a very substantial improvement in the impact properties of the PPO/aromatic vinyl resin materials with a tiny decrease in the Vicat temperature and in the stiffness of the material.

### DESCRIPTION OF THE INVENTION

The present invention relates to a rigid material based on PPO and an aromatic vinyl resin with improved impact strength comprising:

99 to 20% of a resin (A) consisting of a mixture of PPO and of an aromatic vinyl resin,

1 to 80% of an impact modifier comprising at least one block copolymer S-B-M in which:

each block is linked to the other by means of a covalent bond or an intermediate molecule linked to one of the blocks by a covalent bond and to the other block by another covalent bond,

M consists of MMA monomers optionally copolymerized with other monomers and comprises at least 50% by weight of methyl methacrylate (MMA),

B is incompatible with the resin (A) and with the M block and its glass transition temperature Tg is less than the temperature for using the rigid material,

S is incompatible with the B block and the M block and its Tg or its melting point m.p. is greater than the Tg of B,

S is compatible with the resin (A).

As regards PPO which constitutes the resin (A), this term designates polyphenylene oxide also called polyphenylene ether. These polymers are described in Ulmann's Encyclopedia of Industrial Chemistry, publisher VCH, Vol. A 21, pages 605-614, 5th edition, 1992. The PPOs used in the present invention are advantageously those of the following formula (I):

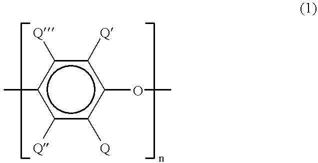

in which Q, Q′, Q″ and Q′″ are independently chosen from the group consisting of hydrogen, alkyl radicals, hydrogenated alkyl radicals having at least two carbon atoms between the halogen and the phenol ring, the alkoxy radicals and the halogenated alkoxy radicals having at least two carbon atoms between the halogen and the phenol ring; Q′, Q″ and Q′″ may also be halogens but preferably Q and Q′ do not contain a tertiary carbon; and n is an integer which is equal to at least 50. The PPO is advantageously poly(2,6-dimethyl-1,4-phenylene) ether.

As regards the aromatic vinyl resin which constitutes the resin (A), aromatic vinyl monomer for the purposes of the present invention is understood to mean an aromatic monomer with ethylenic unsaturation such as styrene, vinyltoluene, alpha-methylstyrene, 4-methylstyrene, 3-methylstyrene, 4-methoxystyrene, 2-hydroxymethylstyrene, 4-ethylstyrene, 4-ethoxystyrene, 3,4-dimethylstyrene, 2-chlorostyrene, 3-chlorostyrene, 4-chloro-3-methylstyrene, 3-tert-butylstyrene, 2,4-dichlorostyrene, 2,6-dichlorostyrene and 1-vinylnaphthalene. The aromatic vinyl resin is advantageously a styrene polymer.

By way of example of a styrene polymer, there may be mentioned polystyrene, polystyrene modified with elastomers, copolymers of styrene and of acrylonitrile (SAN), SAN modified with elastomers, in particular ABS which is obtained by grafting (graft-polymerization) styrene and acrylonitrile onto a backbone of polybutadiene or of butadiene-acrylonitrile copolymer, mixtures of SAN and of ABS. The elastomers mentioned above may be for example EPR (abbreviation for ethylene-propylene rubber or ethylene-propylene elastomer), EPDM (abbreviation for ethylene-propyl ene-diene rubber or ethylene -propylenediene elastomer), polybutadiene, acrylonitrile-butadiene copolymer, polyisoprene, isoprene-acrylonitrile copolymer.

The impact polystyrene may be obtained (i) either by mixing polystyrene with elastomers such as polybutadiene, copolymers of butadiene and acrylonitrile, polyisoprene or copolymers of isoprene and acrylonitrile (ii) or more usually by grafting styrene (graft-polymerization) onto a backbone of polybutadiene or of butadiene-acrylonitrile copolymer.

In the styrene polymers which have just been mentioned, a portion of the styrene may be replaced with unsaturated monomers which are copolymerizable with styrene; by way of example, there may be mentioned alpha-methylstyrene and (meth)acrylic esters. As examples of the copolymers of styrene, there may also be mentioned chloropolystyrene, poly-alpha-methylstyrene, styrene-chlorostyrene copolymers, styrene-propylene copolymers, styrene-butadiene copolymers, styrene-isoprene copolymers, styrene-vinyl chloride copolymers, styrene-vinyl acetate copolymers, styrene-alkyl acrylate (methyl, ethyl, butyl, octyl or phenyl acrylate) copolymers, styrene-alkyl methacrylate (methyl, ethyl, butyl or phenyl methacrylate) copolymers, styrenemethyl chloroacrylate copolymers and styrene-acrylonitrile-alkyl acrylate copolymers. In these copolymers, the content of comonomers is generally up to 20% by weight. The present invention also relates to high-melting point metallocene polystyrenes. Advantageously, the aromatic vinyl resin constituting the resin (A) is chosen from polystyrene and impact polystyrene.

It is quite clear that the PPO and the aromatic vinyl resin (which may already contain an impact modifier) constituting the resin (A) are miscible and that the impact modifier which is added thereto is not a compatibilizing agent for PPO and for the aromatic vinyl resin. The miscibility of the PPO and of the aromatic vinyl resin constituting the resin (A) is defined by the fact that the resin (A) has at least a glass transition temperature Tg between that of PPO and that of the matrix of the aromatic vinyl resin. For example, if the aromatic vinyl resin is a PSchoc, the Tg of the matrix is that of the polystyrene constituting the matrix of the PSchoc. Persons skilled in the art can easily determine by the usual methods of measurement if the PPO and the aromatic vinyl resin are miscible.

The proportions of PPO and of aromatic vinyl resin in the resin (A) may be at any level and advantageously such that the PPO to aromatic vinyl resin weight ratio is between 1/9 and 9/1 and preferably between 3/7 and 7/3.

As regards the triblock S-B-M, M consists of monomers of methyl methacrylate and contains at least 50% by mass of methyl methacrylate, preferably at least 75% by mass of methyl methacrylate. The other monomers constituting the M block may be acrylic monomers or not, or may be reactive or not. By way of nonlimiting examples of reactive functions, there may be mentioned: oxirane functions, amine functions, carboxyl functions. The reactive monomer may be (meth)acrylic acid or any other hydrolysable monomer leading to these acids. Among the other monomers which may constitute the M block, there may be mentioned by way of nonlimiting example glycidyl methacrylate or tert-butyl methacrylate. Advantageously, M consists of syndiotactic PMMA at at least 60%.

Advantageously, the Tg of B is less than 0° C. and preferably less than −40° C.

The monomer used to synthesize the elastomeric B block may be a diene chosen from butadiene, isoprene, 2,3-dimethyl-1,3-butadiene, 1,3-pentadiene, 2-phenyl-1 ,3-butadiene. B is advantageously chosen from poly(dienes), in particular poly(butadiene), poly(isoprene) and random copolymers thereof, or alternatively from partially or completely hydrogenated poly(dienes). Among the polybutadienes, those whose Tg is lowest, for example 1,4-polybutadiene having a Tg (at around −90° C.) below that of 1,2-polybutadiene (at around 0° C.), are advantageously used. The B blocks may also be hydrogenated. This hydrogenation is carried out according to the usual techniques.

The monomer used to synthesize the elastomeric B block may also be an alkyl (meth)acrylate; the following Tg values in parentheses following the name of the acrylate are obtained: ethyl acrylate (−24° C.), butyl acrylate (−54° C.), 2-ethylhexyl acrylate (−85° C.), hydroxyethyl acrylate (−15° C.) and 2-ethylhexyl methacrylate (−10° C.). Ethyl acrylate is advantageously used. The acrylates are different from those of the M block in order to meet the condition of B and M which are incompatible.

Preferably, the B blocks predominantly consist of 1,4-polybutadiene.

The Tg or the m.p. of S is advantageously greater than 23° C. and preferably greater than 50° C. By way of example of S blocks, there may be mentioned those which are derived from aromatic vinyl compounds such as for example styrene, α-methylstyrene, vinyltoluene. Advantageously, the S block consists of the same monomers as the aromatic vinyl resin constituting the resin (A).

The triblock S-B-M has a number-average molar mass which may be between 10,000 g/mol and 500,000 g/mol, preferably between 20,000 and 200,000 g/mol. The triblock S-B-M advantageously has the following composition, expressed as fraction by mass, the total being 100%:

M: between 10 and 80% and preferably between 15 and 70%.

B: between 2 and 80% and preferably between 5 and 70%.

S: between 10 and 88% and preferably between 15 and 85%.

The block copolymers used in the materials of the present invention may be manufactured by anionic polymerization, for example according to the processes described in patent applications EP 524,054 and EP 749,987. They can also be manufactured by controlled free-radical polymerization.

Advantageously, the proportion of impact modifier is 1 to 35% for 99 to 65% of resin (A) respectively.

Preferably, the proportion of impact modifier is 4 to 25% for 96 to 75% of resin (A) respectively.

According to a preferred form of the invention, the impact modifier comprises at least one triblock copolymer S-B-M and at least one diblock copolymer S-B.

As regards the diblock S-B, the S and B blocks have the same properties as the S and B blocks of the triblock S-B-M; they are incompatible and they consist of the same monomers and optionally comonomers as the S blocks and the B blocks of the triblock S-B-M. That is to say that the S blocks of the diblock S-B consist of monomers chosen from the same family as the family of monomers available for the S blocks of the triblock S-B-M. Likewise, the B blocks of the diblock S-B consist of monomers chosen from the same family as the family of monomers available for the B blocks of the triblock S-B-M.

The S and B blocks may be identical or different from the other S and B blocks present in the other block copolymers of the impact modifier in the rigid material.

The diblock S-B has a number-average molar mass which may be between 10,000 g/mol and 500,000 g/mol, preferably between 20,000 and 200,000 g/mol. The diblock S-B advantageously consists of a fraction by mass of B of between 5 and 95% and preferably between 15 and 85%.

The impact modifier advantageously comprises between 5 and 80% of the diblock S-B for 95 to 20% of triblock S-B-M respectively.

Furthermore, the advantage of these compositions is that it is not necessary to purify the S-B-M after its synthesis. Indeed, the S-B-Ms are in general prepared from S-Bs and the reaction often leads to a mixture of S-B and S-B-M which is then separated to obtain S-B-M.

The material of the invention is thermoplastic.

According to another form of the invention, the impact modifier also comprises optionally hydrogenated linear or star-shaped S-B-S block copolymers. That is to say that the impact modifier of the invention may comprise:

either at least one triblock S-B-M,

or at least one triblock S-B-M and at least one diblock S-B,

or at least one triblock S-B-M, at least one diblock S-B and at least one triblock S-B-S which is linear or star-shaped,

or at least one triblock S-B-M and at least one triblock S-B-S which is linear or star-shaped.

S-B-S triblocks are described in ULLMANN'S already cited above Vol. A 26, pages 655-659.

By way of example of S-B-S triblocks, there may be mentioned the linear ones in which each block is linked to another by means of a covalent bond or of an intermediate molecule linked to one of the blocks by a covalent bond and to the other block by another covalent bond. The S and B blocks have the same properties as the S and B blocks of the triblock S-B-M, they are incompatible and they consist of the same monomers and optionally comonomers as the S blocks and the B blocks of the triblock S-B-M. That is to say that the S blocks of the triblock S-B-S consist of monomers chosen from the same family as the family of monomers available for the S blocks of the triblock S-B-M. Likewise, the B blocks of the triblock S-B-S consist of monomers chosen from the same family as the family of monomers available for the B blocks of the triblock S-B-M. The S and B blocks may be identical or different from the other S and B blocks present in the other block copolymers of the impact modifier in the rigid material.

The linear triblock S-B-S has a number-average molar mass which may be between 10,000 g/mol and 500,000 g/mol, preferably between 20,000 and 200,000 g/mol. The triblock S-B-S advantageously consists of a fraction by mass of B of between 5 and 95% and preferably between 15 and 85%.

By way of other example of triblocks S-B-S, there may be mentioned those which are star-shaped. The term “triblock” is not in agreement with the number of blocks but the term “star-shaped triblocks S-B-S” is clear for persons skilled in the art. By way of example of star-shaped triblocks, there may be mentioned those of formula:

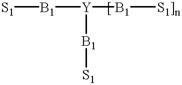

in which n is equal to 1, 2 or 3, and S₁ and B₁ represent blocks. The S₁ blocks represent polymerized styrene and the B₁ blocks polymerized butadiene, polymerized isoprene or a mixture of polymerized isoprene and butadiene. The B₁ blocks may be hydrogenated (they are then for example S-EB-S). Y is a polyfunctional entity derived for example from polyfunctional coupling agents which are used in the manufacture of star-shaped block copolymers. Such agents as well as these block copolymers are described in U.S. Pat. No. 3,639,521.

Preferred star-shaped block copolymers contain 15 to 45% by weight and even better 25 to 35% of styrene units. The molar mass is at least 140,000 and even better at least 160,000.

Particularly preferred star-shaped block copolymers are those described in EP 451920. These copolymers are based on styrene and isoprene, the molar mass of the styrene blocks is at least 12,000 and the styrene content is at most 35% (weight) of the total mass of the block copolymer. The preferred linear block copolymers have a molar mass between 70,000 and 145,000 and contain 12 to 35% by weight of polystyrene. Particularly preferred block linear block copolymers are those based on styrene and isoprene which are described in European Patent EP 451919. These copolymers have polystyrene blocks with a molar mass between 14,000 and 16,000 and a polystyrene content of between 25 and 35% by weight of the block copolymer. The molar mass is between 80,000 and 145,000 and even better 100,000 and 145,000.

It is also possible to use a mixture of linear triblocks S-B-S and of star-shaped triblocks S-B-S. These linear or star-shaped triblocks S-B-S are commercially available under the trademarks Finaprene®, Finaclear®, Kraton® and Styrolux®.

The proportion of triblock S-B-S may represent up to 40% by weight of the impact modifier.

There would be no departure from the scope of the invention by replacing all or part of the triblock S-B-M with a pentablock M-B-S-B-M. They may be prepared by controlled free-radical or anionic polymerization like the di- and triblocks mentioned above but using a difunctional primer. The number-average molar mass of these pentablocks is in the same ranges as that of the triblocks S-B-M. The proportion of the two M blocks together, of the two B blocks together is in the same ranges as the proportions of S, B and M in the triblock S-B-M.

The material of the invention may also contain the usual additives of PPO and of the aromatic vinyl resin. There may be mentioned by way of example flame retardants, colorants, pigments, anti-UV agents, antioxidants, glass or carbon fibres, plasticizers, antistatic additives, processing aids and inorganic fillers such as silica or calcium carbonate. The proportion of these additives does not exceed 50% by weight of the combination resin (A), impact modifier and additives.

The materials of the invention are manufactured by mixing, in the molten state, the various constituents (twin-screw, BUSS or single-screw extruders) according to the usual thermoplastic techniques. The compositions may be granulated for subsequent use (they simply have to be melted again) or injected immediately into a mould, an extrusion or coextrusion device for manufacturing tubes or sections, or a device for manufacturing films.

### EXAMPLES

Products Used:

PPO: this is a product based on poly(2,6-dimethyl-1,4-phenylene) ether, marketed by the company HUELS under the reference VESTORAN 1900 nf. It is characterized by an MVR of 25 cm³/10 min at a temperature of 300° C. under a load of 21.6 kg.

PS: this is a polystyrene marketed by the company Elf Atochem under the reference LACQRENE 1540. It is characterized by an MVR of 12 cm³/10 min at a temperature of 200° C. under a mass of 5 kg.

PSchoc: this is a polystyrene which is strengthened against impact, High Impact PS, marketed by the company Elf Atochem under the reference LACQRENE 6631. It is characterized by an MVR of 13 cm³/10 min at a temperature of 200° C. under a mass of 5 kg.

S-EB-S: this is a triblock copolymer, Polystyrene-b-Polyethylene butene-b-Polystyrene, marketed by the company Shell under the reference Kraton G 1650.

S-B-M: this is a mixture of a triblock copolymer, Polystyrene-b-Polybutadiene-b-Polymethylmethacrylate and of a diblock copolymer, Polystyrene-b-Polybutadiene. The diblock S-B is the species which served for the preparation of the triblock S-B-M. The S-B-M/S-B mixture contains 65% by weight of S-B-M and 35% of diblock S-B. These block copolymers have the following characteristics:

SBMI : this is a triblock copolymer S-B-M in which S is polystyrene, B is polybutadiene and M is PMMA containing 27% as fraction by mass of polystyrene, 27% as fraction by mass of polybutadiene and 46% by mass of polymethyl methacrylate, obtained by anionic polymerization successively of a block polystyrene having a number-average molar mass of 27,000 g/mol, of a block polybutadiene having a mass of 27,000 g/mol and of a block polymethyl methacrylate having a number-average molar mass of 46,000 g/mol. This product was prepared according to the procedure described in EP 524,054 and in EP 749,987. This product has three glass transitions, one of −90° C., the other of 97° C. and the third of 130° C.

SBI : this is a diblock copolymer S-B in which S is polystyrene and B is polybutadiene containing 50% as fraction by mass of polybutadiene and 50% by mass of polystyrene, obtained by anionic polymerization successively of a block polystyrene having a number-average molar mass of 27,000 g/mol and a block polybutadiene having a mass of 27,000 g/mol. This product was prepared according to the procedure described in EP 524,054 and in EP 749,987. This product has two glass transitions, one of −90° C. and the other of 95° C.

Preparation of the materials: the mixtures of PPO, PS or PSchoc and S-B-M were produced in a twin-screw extruder of Werner trademark, having a screw diameter of 30. The temperature profile used is 270° C./280° C. Below these temperatures, PPO does not melt. With the profile used, the rod obtained is smooth and homogeneous.

The compositions and the properties of the materials are reported in the following tables 1 and 2 in which the proportions are by weight. The properties of the material are measured according to the following standards:

MVR: measurement of the fluidity of the product under a weight of 2.16 kg at 280° C.

Modulus: flexural modulus at 23° C. measured according to the ISO 178:93 standard

Vicat: Vicat 50N measured according to the ISO 306:94-B50 standard

NCl: notched Charpy impact measured at 23° C. and at −30° C. according to the ISO 179:93-1eA standard.

TABLE 1

| | Nature of | Nature of the | | | |
|---|---|---|---|---|---|
| Reference | the PS | triblock | % PPO | % PS | % triblock |
| Control 1 | PS | x | 40 | 60 | |
| Control 2 | PS choc | x | 40 | 60 | |
| Control 3 | PS | S-EB-S | 32 | 48 | 20 |
| Control 4 | PS choc | S-EB-S | 32 | 48 | 20 |
| Example 1 | PS | S-B-M | 32 | 48 | 20 |
| Example 2 | PS choc | S-B-M | 32 | 48 | 20 |

TABLE 2

| | MVR | Modulus | Vicat | NCl: 23° C. | NCl: −30° C. |
|---|---|---|---|---|---|
| Reference | (cm³/10 min) | (MPa) | (° C.) | (kJ/m²) | (kJ/m²) |
| Control 1 | 14.5 | 2820 | 118.9 | 1.4 | 1.5 |
| Control 2 | 10.5 | 2240 | 117.8 | 15.4 | 7.5 |
| Control 3 | 8.5 | 2080 | 105.1 | 22.3 | 5.2 |
| Control 4 | 5.5 | 1540 | 97.4 | 37.2 | 16.5 |
| Example 1 | 8.5 | 2240 | 114.4 | 12.7 | 6.4 |
| Example 2 | 5.5 | 1800 | 112.9 | 31.7 | 19.4 |

Comments:

The PPO/IPS mixture (control 1) is a rigid material (2820 MPa) which has a high Vicat temperature but which is extremely fragile. It is well known that the replacement of polystyrene with a grade of polystyrene strengthened against impact makes it possible to substantially improve the impact strength of the PPO/PS mixture (control 2). This improvement in impact results in a slight decrease in the modulus and a slight decrease in the Vicat temperature.

Tests 3 and 4 were carried out with the objective of illustrating the strengthening provided by the addition of S-EB-S copolymers to the PPO/PS mixtures. It is observed that the addition of 20% of triblock S-EB-S allows a very significant improvement in the impact strength at room temperature. The improvement in impact strength at low temperature (−30° C.) is more limited but remains substantial. On the other hand, the addition of S-EB-S results in a very substantial reduction in the stiffness of the material. Indeed, a decrease of 700 MPa in modulus is observed between the controls 1 and 3 (PPO/PS) and between the controls 2 and 4 (PPO/PSchoc). Furthermore, this decrease in modulus is accompanied by a decrease which rules out the applications of Vicat temperature: a loss of 14° C. between controls 1 and 3 and a loss of 20° C. between controls 2 and 4. Consequently, this solution is not satisfactory, the excellent impact properties of the control 4 are obtained at the expense of a decrease in modulus and in Vicat which is too high.

Examples 1 and 2 were carried out under the same conditions as all the preceding controls. We observed that the conversion protocol does not have a destructive effect on the product based on the triblock S-B-M PS-PB-PMMA. After conversion, the solubility, in chloroform, of the mixtures produced was tested. No crosslinking of the product is produced.

The addition of 20% of a product based on the triblock S-B-M PS-PB-PMMA to the PPO/PS and PPO/PSchoc mixtures introduces no modification in fluidity compared with the triblock S-EB-S. Examples 1 and 2 can therefore be compared respectively to controls 3 and 4 at equal viscosities. The strengthening obtained is comparable at room temperature; on the other hand, the triblocks PS-PB-PMMA make it possible to obtain greater strengthening at low temperature (−30° C.). The most surprising result consists nevertheless in the thermomechanical behaviour of the products. Indeed, compared with the controls 1 and 2, the improvement in the impact properties is only obtained at the expense of a tiny decrease in the modulus (400 MPa) and of a very limited decrease in the Vicat temperature (4° C. and 5° C. respectively).

The triblocks S-B-M therefore allow a very substantial improvement in the impact properties of the PPO/PS materials with a tiny decrease in the Vicat temperature and in the stiffness of the material. It is this particular compromise which, as we show here, is very different from that obtained with triblocks S-EB-S, which constitutes the advantage of our invention.

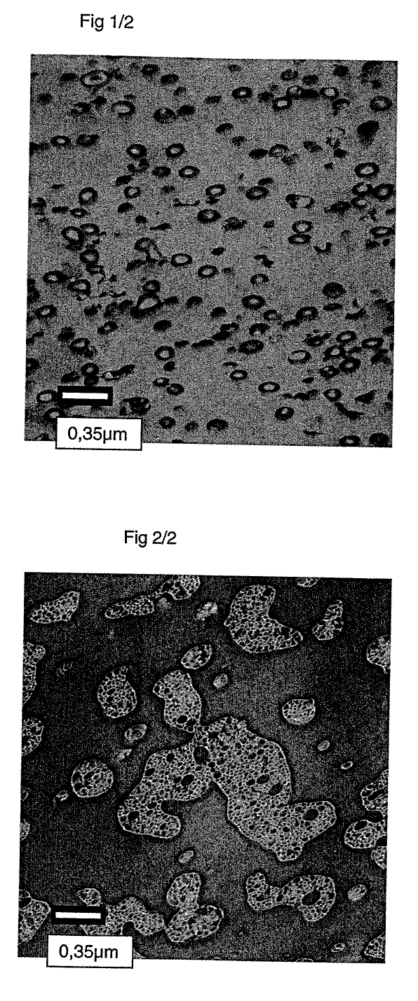

An electron micrograph of Example 2 and of the control 4 is represented in FIGS. 1/2 and 2/2 respectively.

Prior to the observation, the sections were exposed to osmium tetroxide fumes for 30 minutes. The effect of this treatment is a selective marking of the domains consisting of B or of EB which then appear with the darkest colour on the negatives.

### BRIEF DESCRIPTION OF DRAWINGS

There can be seen clearly in FIG. 1/2 a fine and regular dispersion of nodules having a core consisting of M blocks and a crust consisting of B blocks, the S blocks being miscible with the PPO/PS matrix. A rough mixture can be seen in FIG. 2/2; the white parts of the large nodules consist of the S blocks of the S-EB-Ss which are segregated.

Although the invention has been described in conjunction with specific embodiments, it is evident that many alternatives and variations will be apparent to those skilled in the art in light of the foregoing description. Accordingly, the invention is intended to embrace all of the alternatives and variations that fall within the spirit and scope of the appended claims. The foregoing references are hereby incorporated by reference.

1. Rigid material based on PPO and an aromatic vinyl resin with improved impact strength comprising:
99 to 20% of a resin (A) consisting of a mixture of PPO and of an aromatic vinyl resin,
1 to 80% of an impact modifier comprising at least one block copolymer S-B-M in which:
each block is linked to the other by a covalent bond or an intermediate molecule linked to one of the blocks by a covalent bond and to the other block by another covalent bond,
M consists of MMA monomers optionally copolymerized with other monomers and comprises at least 50% by weight of methyl methacrylate (MMA),
B is incompatible with the resin (A) and with the M block and its glass transition temperature Tg is less than the temperature for using the rigid material,
S is incompatible with the B block and the M block and its Tg or its melting point m.p. is greater than the Tg of B,
S is compatible with the resin (A).

2. Material according to claim 1, wherein the M blocks consist of syndiotactic PMMA at at least 60%.

3. Material according to claim 1, wherein the M blocks comprise reactive monomers, which include glycidyl methacrylate or tert-butyl methacrylate.

4. Material according to claim 1, wherein the Tg of the B blocks is less than 0° C.

5. Material according to claim 4, wherein the Tg of the B blocks is less than −40° C.

6. Material according to claim 5, wherein the B blocks consist essentially of 1,4-polybutadiene.

7. Material according to claim 4, wherein the dienes of the B block are hydrogenated.

8. Material according to claim 4, wherein the B block consists of poly(butyl acrylate).

9. Material according to claim 1, wherein the-Tg or the m.p. of S is greater than 23° C.

10. Material according to claim 9, wherein the Tg or the m.p. of S is greater than 50° C.

11. Material according to claim 10, wherein S is polystyrene.

12. Material according to claim 1, wherein the number-average molar mass of the block copolymer S-B-M may be between 10,000 g/mol and 500,000 g/mol.

13. Material according to claim 12, wherein the number-average molar mass of the block copolymer S-B-M may be between 20,000 g/mol and 200,000 g/mol.

14. Material according to claim 1, wherein the proportion of impact modifier is 1 to 35% for 99 to 65% of resin (A) respectively.

15. Material according to claim 14, wherein the proportion of impact modifier is 4 to 25% for 96 to 75% of resin (A) respectively.

16. Material according to claim 1, wherein the impact modifier comprises at least one block copolymer S-B-M and at least one polymer selected from the diblock copolymers S-B.

17. Material according to claim 16, wherein the S and B blocks of the diblock S-B are those of claim 1.

18. Material according to claim 17, wherein the diblock S-B has a number-average molar mass which is between 10,000 g/mol and 500,000 g/mol.

19. Material according to claim 1, wherein the impact modifier also comprises at least one triblock S-B-S selected from the linear triblocks S-B-S and the star-shaped triblocks S-B-S.

20. Material according to claim 1, wherein all or part of the triblock S-B-M is replaced with a pentablock M-B-S-B-M.

21. Material according to claim 1, wherein the aromatic vinyl resin constituting the resin (A) is selected from polystyrene and impact polystyrene.

22. Material according to claim 1, wherein the PPO to aromatic vinyl resin weight ratio is between 1/9 and 9/1. 23. Material according to claim 22, wherein the ratio is between 3/7 and 7/3.
